(19) United States
(12) Patent Application Publication
(10) Pub. No.: US 2016/0019472 A1
(43) Pub. Date: Jan. 21, 2016

(54) SYSTEM AND METHOD FOR ORGANIZING A GROUP ACTIVITY FOR MULTIPLE PAYING PARTIES

(71) Applicant: TableDivide, Inc., Indianapolis, IN (US)

(72) Inventor: John Matthew Javit, Indianapolis, IN (US)

(21) Appl. No.: 14/332,786

(22) Filed: Jul. 16, 2014

(51) Int. Cl. G06Q 10/02; G06Q 20/22; G06Q 20/10

(52) U.S. Cl. CPC G06Q 10/02; G06Q 20/10; G06Q 20/22

(57) ABSTRACT

Disclosed is a computer implemented system and method for organizing a group activity for multiple paying parties. Venues can offer group activities and participation in the events may be organized by a host user according to terms defined by the host. The terms may include a fee splitting arrangement dividing the cost of the group activity between proposed participants. The terms may be communicated to invitees who can agree to the fee splitting arrangement. An activity may be reserved with the venue when all parties have agreed to the fee splitting arrangement and the fee has been collected.

### BACKGROUND

Entertainment venues such as nightclubs, bars, restaurants, dinner theaters and others often provide group activities that are not available or which can be expensive if the participants are only a small number of people such as one or two individuals. One example is table service often provided by nightclubs. Table service can be desirable over regular admission because it can provide a higher level of service to the customer, and entry into the establishment may be easier as lines may be shorter for a reserved table with table service as opposed to general admission. However, a reserved table with table service is generally expensive. Table service often includes prime space in the venue arranged for multiple participants and the dedicated attention of wait staff, both of which can make the price prohibitively expensive for people seeking to attend in smaller groups such as in pairs. The result can be that prospective attendees choose to pay for general admission, visit another venue with shorter lines, or do not attend any venue. This can result in a loss of business and/or lower revenue for the nightclub as table space may be left unoccupied.

Similar difficulties can arise in other types of venues where a particular resource or set of resources may only be reserved by a group but when the overall group cost may be too expensive for an individual or smaller group such as a couple. In some cases these activities may not be reserved until a group with a specified number of individuals agrees to participate and has committed to pay. Examples of this might include almost any group activity such as a watercraft or aircraft reservation for a sightseeing tour, reserving a luxury suite in an arena, and the like. This can result in lost opportunities for the venue and missed opportunities for individuals to participate in the activities.

### SUMMARY

Disclosed is a computer implemented system and method for organizing a group activity for multiple paying parties. The system offers the ability to organize a group activity and divide the activity fee between the users. This allows participants to split the fee and to attend an event at a cost that is acceptable to them without being required to pay the entire cost. It also enables venue operators to fill reservations they may not otherwise be able to fill. The system provides individuals a way to negotiate a fee splitting arrangement whereby the group can together assemble the total fee and participate in the event while meeting the vender's requirement that full payment be received in advance from a single source.

The system may be implemented using one or more computers or computer components including software, hardware, and networking infrastructure to receive information about a group activity from a venue and store that information in a knowledge base, the group activity having a predetermined number of participants, and a predetermined reservation fee required to reserve the group activity. The system may accept input from a host user using a personal computing device and communicate it to a coordinating computer, the input defining one or more invitees and a fee splitting arrangement dividing the predetermined fee. It may send invitations to the invitees to participate in the group activity with the host user under the fee splitting arrangement using the coordinating computer communicating with personal computing devices of the invitees. The system can then receive information from the personal computing devices of the invitees who are confirming acceptance of the invitation and agreeing to pay part of the predetermined fee using the coordinating computer. Funds may be transferred from the invitees using the coordinating computer when a count of confirmed invitees satisfies the predetermined number of participants and the sum of confirmed payments satisfies the predetermined fee. The group activity may be reserved for the confirmed invitees using the coordinating computer when the action of transferring the funds is successfully completed.

The system may include other aspects such as the ability to accept input from a user (e.g. an invitee user) modifying the fee splitting agreement after the invitation has been sent and then notifying the invitees of the modified fee splitting agreement using the coordinating computer.

The system may also be configured to accept search criteria specifying users or group activities a searching user is interested in participating in with other users. The search criteria may be received by the coordinating computer from a personal computing device and passed to the knowledge base where information about users and group activities is stored. The search criteria may include a location automatically provided by the personal computing device enabling the user to find other nearby users or venues.

In some implementations of system, the personal computing device of the host and the coordinating computer may be the same computing device. In this configuration, personal computing devices communicate directly with the knowledge base, the venues, and with each other.

In another aspect, the system may calculate reservation metadata sent to venues that may include information such as an elapsed time indicating the time between when the host invitation is sent, and the reservation is sent to the venue. The system may be configured to allow venues to modify future offerings accordingly such as by updating unreserved group activities currently in the knowledge base to include a different fee.

### BRIEF DESCRIPTION OF THE DRAWINGS

FIG. 1 is a schematic diagram illustrating some components of the disclosed system for organizing a group activity for multiple paying parties.

FIG. 2 is a schematic diagram illustrating an alternate configuration of the system of FIG. 1.

FIG. 3 is a flowchart illustrating the operation of the system of FIG. 1.

FIG. 4 is a flowchart illustrating additional detail for interactions with the venue using the system of FIG. 1.

FIG. 5 is a flowchart illustrating additional detail for interactions with a user searching for group activity using the system of FIG. 1.

FIG. 6 is a flowchart illustrating additional detail for interactions with a host user using the system of FIG. 1.

FIG. 7 is a flowchart illustrating additional detail for interactions with that invitee user using the system of FIG. 1.

FIG. 8 is a flowchart illustrating additional detail describing fee processing for the system of FIG. 1.

FIG. 9A-9F are schematic diagrams illustrating examples of various terms of participation for the system of FIG. 1.

FIG. 10 is a schematic diagram illustrating additional detail for a computing device used in the system of FIG. 1.

FIG. 11 is a schematic diagram illustrating additional detail for the arrangement of components that may be present in the system of FIG. 1.

### DETAILED DESCRIPTION

For the purpose of promoting an understanding of the principles of the invention, reference will now be made to the examples illustrated in the drawings and specific language will be used to describe the same. It will nevertheless be understood that no limitation of the scope of the invention is thereby intended. Any alterations and further modifications in the described examples, and any further applications of the principles of the invention as described herein are contemplated as would normally occur to one skilled in the art to which the invention relates. At least one example of the invention is disclosed in detail, although it will be apparent to those skilled in the relevant art that some features that are not relevant to the present invention may not be shown for the sake of clarity.

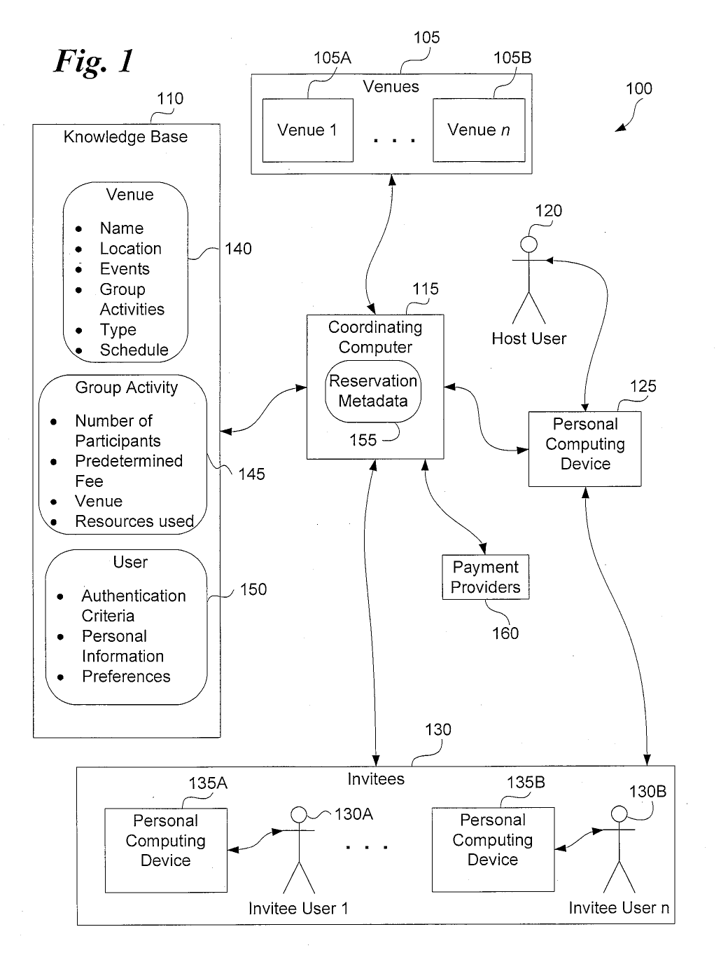

FIG. 1 illustrates at 100 one example of a system for dividing a fee for a group activity between users seeking to participate in a group activity provided by a venue. Venues 105 (including any number of venues such as venue 105A and venue 105B) can communicate with a coordinating computer 115 that may be configured to pass information between a host user or users 120, invitee users 130, and a knowledge base 110. Host user 120 can interact with system 100 using a personal computing device 125 in communication with coordinating computer 115. Invitee users 130 may interact with system 100 using personal computing devices 135A, 135B, or other similar computing devices. Knowledge base 110 can be configured to store information used by system 100 to coordinate group activities 145 provided by venues 105 and includes venue profiles 140, group activities 145, and other users 155.

A venue 105 may be any facility offering events or activities or where events may take place, for example, on a predetermined schedule available days, weeks or months in advance, on a recurring basis such as daily, hourly, or on an ad hoc basis whenever a sufficient number of participants are available. Example venues 105 include night clubs, bars, pubs, restaurants, taverns, bistros, cafes, lounges, theaters, concert halls, convention centers, stadiums, theme parks, open air stages, and the like. Venues 105 may also include tourist attractions offering activities that may be participated in as a group.

Group activities include any type of activity that has a predetermined number of participants and a predetermined fee set by the venue that is to be paid before the group can participate in the activity. In this regard, a group activity may be distinguishable from activities participated in by a large number of people who may purchase individual tickets or seats. In a group activity, the venue 105 determines a group price, rather than a price per individual. The venue seeks to collect a single fee for a predetermined number of participants. Examples of a group activity include table service at a nightclub where the venue sets the predetermined price for a certain number of individuals to occupy an area such as a table, booth, room and the like, for a particular event or period of time at a single predetermined price for all participants. Other examples of group activities may include reserving the use of equipment such as a boat, helicopter, amusement ride, and the like having a fixed number of seats the venue may rent at a predetermined price for a group of participants of a specific size.

User information 150 stored in knowledge base 110 includes authentication criteria such as a username and password, personal information about a user, personal preferences, and any other information specific to individual user. Not all users must have user information 150 in the knowledge base. For example, a first time user responding to an invitation may interact with system 100 without user information 150 in knowledge base 110. Other types of users include host users 120, and invitee users 130.

A host user 120 using personal computing device 125 may organize a group activity offered by a venue 105. The host user may set terms for participation, and invite other users to participate in the activity. An invitation may be communicated using coordinating computer 115 to invitees 130 who can then use personal computing devices 135 to respond to the invitation. Invitees 130 may accept the terms offered by host 120, or may optionally propose different terms of participation as well. Terms of participation may include a payment commitment by the invitee, or if no payment commitment is required, an acceptance of the offer to participate along with an acceptance of any other terms and conditions that may be imposed by the host user 120 or venue 105.

Coordinating computer 115 can initiate funds transfers to receive funds from the participants. This can occur when the number of confirmed invitees satisfies the predetermined number of participants, and when the sum of confirmed payment commitments satisfies the predetermined fee required by the venue 105. Alternately, funds can be transferred when an invitation is accepted. In one example, coordinating computer 115 transfers funds from participants including invitees 130 and host 120 by communicating with, instructing and/or using one or more payment providers 160. Payment providers 160 may include any suitable bank or other financial institution capable of electronically transferring funds based on input from the participants using personal computing devices 125 and 135. In this way, system 100 and coordinating computer 115 facilitate or initiate the transfer of money at the direction of the participants but do not necessarily operate as a bank for the purpose of maintaining accounts, collecting money, and the like. These activities may be carried out by payment providers 160.

When the funds agreed to in the terms have been transferred, coordinating computer 115 communicates with venue 105 to reserve the group activity for the confirmed invitees 135 and the host 120 and initiates a transfer of funds to the venue 105. Confirmation of the reservation can then be communicated to host 120 and invitees 135 which may include any kind of group ticket or group confirmation number, or other identifying information that group members may present at the venue to gain entry and to participate in the group activity.

Reservation metadata 155 may be sent to venue 105 when the reservation has been confirmed with the venue. Reservation metadata 155 may include a broad range of detailed information about the process of arranging and finalizing participation in the group activity and confirming a reservation with venue 105. Examples include the composition of the group agreeing to the terms such as gender, age, occupation, and the like. Reservation metadata 155 may also include information about how much of the fee each participant in the group agreed to pay, the amount of time between sending the host invitation and the final funds transfer to the venue, whether changes to the terms of participation were suggested by invitees 130 or host 120, and whether these changes were accepted or not. Metadata 155 may also include information about participants who failed to successfully transfer money, information about participants who were specifically included or excluded in an invitation by host 120, and information about invitations various invitees 130 considered before accepting one and what venue or system generated messaging the invitees may have seen in the process. Any information about the group activity and the group's response that may be useful to the venue 105 in planning future events may be included in reservation metadata 155.

With respect to planning future events, reservation metadata 155 may be analyzed and used by a venue 105 to make adjustments to future offerings. Various analytical processes may be performed by venues 105 to optimize the activities offered and the prices associated with them. For example, if the amount of time between sending the host invitation and the final funds transfer to the venue is shorter than a predetermined threshold, venue 105 may decide current demand warrants an increase in the fees for some or all future group activities. A venue 105 may also remove group activity postings which have not been reserved and repost them with changed fees, and it may do so even if a group activity is in a pending state after a host user 120 has sent invitations seeking invitees 130 to join in the activity. On the other hand, system 100 may maintain the terms agreed to by participating invitees while the group activity is in a pending state and host user 120 is waiting for remaining invitees 130 to respond. In this example, venues 105 may be allowed to adjust fees and other requirements for a group activity if the activity remains unreserved beyond a predetermined period of time, if no hosts 120 are currently attempting to organize a group for the activity, or if a host 120 has organized a group activity but no invitees 130 have responded yet. In this way, terms agreed to by invitees are maintained while the group activity is pending. Venues may monitor reservation metadata received during peak usage times (e.g. weekends or holidays) and adjust group activity fees accordingly to optimize sales and profits. For example, venue monitoring of fee splitting activity may occur multiple times in an evening, or even multiple times per hour during the course of an event or series of events.

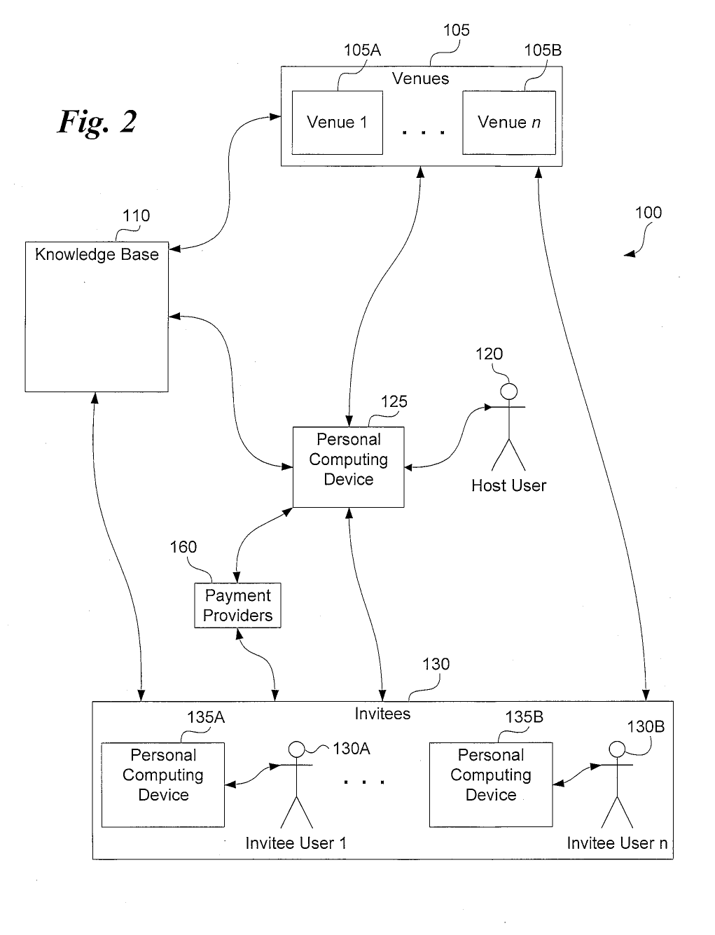

FIG. 2 illustrates an alternative configuration for system 100 which is similar to the configuration in FIG. 1 but without a separate coordinating computer 115. In this configuration, a personal computing device 125, for example operated by host user 120, may take on the role of coordinating the proposal and acceptance of terms to invitees 130. Knowledge base 110 may communicate directly with venues 105, the host computing device 125 and invitee computing devices 135 exchanging information regarding available group activities, payment obligations accepted, payments received, and the like. Similarly, venues 105 may communicate directly with host and invitee users 120 and 130 respectively via personal computing devices 125 and 135. In this example of system 100, personal computing device 125 may include the functionality of coordinating computer 115. It may also be the case that personal computing devices 135 also include the functionality of coordinating computer 115 as an invitee 130 and host user 120 may be thought of as roles played by persons involved in group activity. These roles may change as a host user may be invited to participate in another group activity, and an invitee 130 may decline an invitation and become a host user 120 by hosting a separate group activity. Therefore the functionality required to coordinate interactions between hosts 120, invitees 130, knowledge base 110, and venues 105 may be included in personal computing devices 125 and 135.

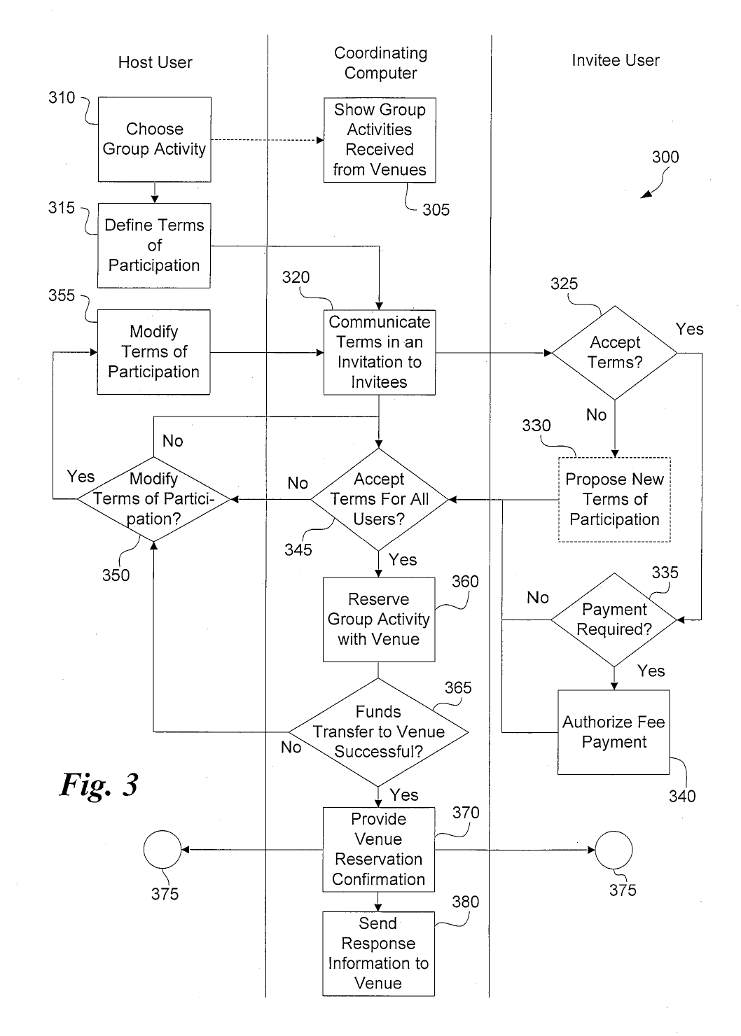

Additional detail for system 100 is illustrated at 300 in FIG. 3. Group activities145 previously loaded into the system by venues 105 are shown or otherwise made available to system users (305). For example, the group activities may be listed on a web page, or on an app running on a smart phone or tablet computer. An activity may be listed by selecting a particular venue 105 and requesting to see available activities. An activity may also be selected from search results based on criteria defined by the user, a process discussed in further detail below. A host user 120 organizing a group activity may choose a group activity (310) from the group activities 145 provided by a particular venue 105. Host user 120 may define terms under which other users may participate in the group activity (315). The system may validate the terms against a set of validation rules and reject them if the terms proposed by host user 120 are invalid.

An invitation to participate in the group activity can be communicated to the invitees specified in the terms (320). An invitation may be sent to a specific user or group of users, or posted for acceptance by any user including individuals who have never used system 100 in the past. Posting or communicating an invitation can include storing the group activity in knowledge base 110 so that it may appear as part of a search result. Search results may be based on search criteria input by a user, or based on default criteria included in system 100 for the purpose of automatically generating lists on particular web pages or application user interfaces. One example of an automatically generated list includes a list of events appearing on a landing page directed toward new users and created to entice participation. In another example, system 100 may generate or provide venue specific lists of events for display on separate landing pages or screens configured for individual venues 105 for use in their marketing campaigns. In yet another example, an invitation may be communicated by host 120 by electronically posting or publishing a web link or other similar reference to the invitation in a private or public forum such as a third-party website or using a third-party application. Examples include private or public personal webpages, blogs, or social media outlets such as Facebook, Twitter, Linkedln, MySpace, Google Plus+, Instagram, Meetup, VK, and the like. Accepting the invitation may then be as simple as clicking a posted link, or clicking a link and providing additional input on the resulting page or user interface screen before accepting.

The system may allow the group activity with accompanying terms to be available in system 100 until all users have accepted the terms (345), or for some predetermined period of time, for example up to 15 minutes, up to 30 minutes, up to 24 hours, up to a week, up to two weeks, or some other suitable period of time that may be shorter or longer. As invitations are being reviewed, system 100 may automatically generate warning or reminder messages directing attention toward particular activities or events. For example, for certain venues or events where the reservations are being confirmed rapidly, notification may be generated as users are browsing search results and choosing an activity (310) in order to entice involvement. Such messaging might include “Hurry! Event X is filling up fast!” or “Be the first to get into Y tonight!” and the like. System 100 may allow venues 105 to control these messages to target them based on information about the viewing user as well. In another example, a warning message may be provided to a host user 120, and invitees 130 when a group activity has remained unconfirmed for a predetermined period time. In another example, host user 120 may directly message, call, e-mail, or otherwise encourage participation from invitees 130.

Invitee users 130 may receive the invitation from a host user 120, or find a group activity as more generally and/or publicly posted by a hosting user 120 by searching for available group activities using a search or listing system. Invitee users 130 may accept terms included with the invitation (325) or optionally may propose new terms of participation (330). If the terms for an invitee 130 include a payment commitment (335), then the invitee 130 can authorize a fee payment as part of accepting the terms of participation (340). This may involve communications with a payment provider 160, for example system 100 may notify the provider 160 that funds will be needed and request availability information and a fund hold. Authorization stage 340 may also be a communication with payment provider 160 authorizing a transfer of funds at that time, such as in a direct debit scenario. System 100 may wait at 345 for other invitees to accept the host user's terms as multiple invitees may be acting on the invitation simultaneously.

A host user 120 may have the option to control who will be included in the group. For example, as host user 120 waits at 345 for all invitees to accept the terms, the host 120 may not be comfortable participating in the event with some of the invitees 130 who have accepted the terms. In such a case, system 100 may provide host user 120 with an option to deny access to the group activity to individual invitees, making the invitation available to other invitees 130. System 100 may also provide options allowing users to “black list” certain participants. Host users 120 may designate identifying information such as name, user ID, email address and the like for those individuals who should not be allowed to view or respond to general invitations from the corresponding host users. This identifying information may be stored in knowledge base 110 as part of the users' profile information. System 100 may later retrieve the “black list” and actively screen group activities so that people on the list cannot see the group activities hosted by a particular host user 120, or so that people on the list are shown an error message if they attempt join a group event hosted by a user who has asked to exclude them.

System 100 may be configured to allow the host to modify the terms of participation (355) for the group activity after the initial invitation has been communicated to the invitees. For example, a host user 120 may change the terms by adding the requirement that one or more invitees be a particular gender. In another example, the terms may be modified to include additional invitees, to change the amount each invitee is required to pay possibly allowing some invitees to attend for free, or any combination thereof In this example, invitees are added while the fee splitting arrangement is unchanged. In another example, the fee splitting arrangement may be changed to increase or decrease the payment commitment for each invitee. The system may allow the host to adjustment a specific dollar amount to be paid by each user, or change a percentage to be paid by each user, and the like.

The system may be configured to allow invitees some measure of control over changes to the fee splitting agreement. For example, system 100 may not allow a fee splitting agreement to be changed after it has already been agreed to by one or more invitees. In another example, system 100 may allow a fee splitting agreement to be changed with the permission of invitees who have already accepted. In another example, changes to the fee splitting agreement may apply only to open invitations and not to invitees who have already accepted and authorized a payment.

As illustrated in FIG. 3, if some of the invitees have not yet accepted the terms (345), the host user can decide whether to modify terms of participation (350), make the modifications to the terms (355), and communicate the modified terms to the invitees (320). If a host user 120 does not modify terms of participation (350), system 100 can continue to wait until all users accept the terms (345), or perhaps for some predetermined period of time such as 15 minutes, 30 minutes, or some other suitable time. After this time period passes, the invitation may be automatically removed by system 100.

When all users have accepted the proposed terms (345) for the group activity, coordinating computer 115 can reserve the group activity with venue 105 at 360. The coordinating computer 115 may initiate a transfer of funds from the invitees 130 and the host 120 to the venue 105 at 365 according to the terms of participation to satisfy the predetermined fee. When the transfer of funds succeeds, venue 105 may provide a reservation confirmation (370) or similar information from the vendor which will allow the group members to gain access to the venue 105 for the group activity. Both host and invitee users may receive the reservation confirmation completing the process of organizing and splitting the cost of a group activity (375). Coordinating computer 115 may send reservation metadata to the venue (380) providing feedback with respect to various aspects of the transaction such as how long it took, the types of users who responded favorably, users that declined, users that were denied by the host, and the like.

System 100 may be configured to allow multiple users to offer terms for engaging in the same group activity. This aspect of system 100 can allow invitees to search for and choose between many different fee splitting arrangements or group configurations for the same group activity and accept the terms most favorable to their individual interests and financial constraints. It can also mean that the actions illustrated in FIG. 3 may be occurring simultaneously for many host users 120 and invitees 130. The system may be configured to allow an unlimited number of host users 120 to organize terms for engaging in the same group activity, and that the first group of participants with a confirmed payment to venue 105 may be the only group receiving that particular reservation. A side effect of this result is that other hosts 120 and invitees 130 currently performing the actions illustrated in FIG. 3 such as accepting terms (325), authorizing payments (340), proposing new terms (330), or waiting for more invitees (345) may (without warning) receive notice from system 100 that the activity they have been seeking to reserve as a group is now unavailable. Other messages may also appear as previously noted drawing attention to certain venues 105, group activities , user errors, system issues, and the like. System 100 may then also take any necessary actions to refund or unencumber funds paid by invitees who have already accepted these requirements. Such a configuration allows venues to generate a sense of urgency amongst hosts and invitees.

In another example of system 100, only one host user 120 may define terms of participation for a given event at a time. For example, system 100 may be configured to allow only one host user 120 to perform actions beyond 305 at a time once a host user 120 has chosen a group activity at 310 or defined terms of participation at 315. In this configuration, system 100 allows a host user 120 the certainty of knowing they will have a predetermined period of time to assemble a group of invitees. As noted earlier, system 100 can employ a timeout option which can automatically expire causing a group activity organized by a host 120 to be removed after a predetermined period of time passes without the group activity being reserved. Such expiration may occur after 2 minutes, after 30 minutes, after 12 hours, after a day, or more, to name a few examples. System 100 may also include an option allowing host users to request to wait in a queue for the opportunity to prepare their terms for participation in the event while another host user 120 is currently organizing a group and awaiting responses from invitees. Subsequent host users 120 can thus choose an activity (310) that has already been chosen, define the terms of participation (315) in advance, and system 100 will automatically apply them and communicate the terms to invitees (320) if the current group activity expires before the current host user 120 assembles a group (345) and pays the reservation fee (365).

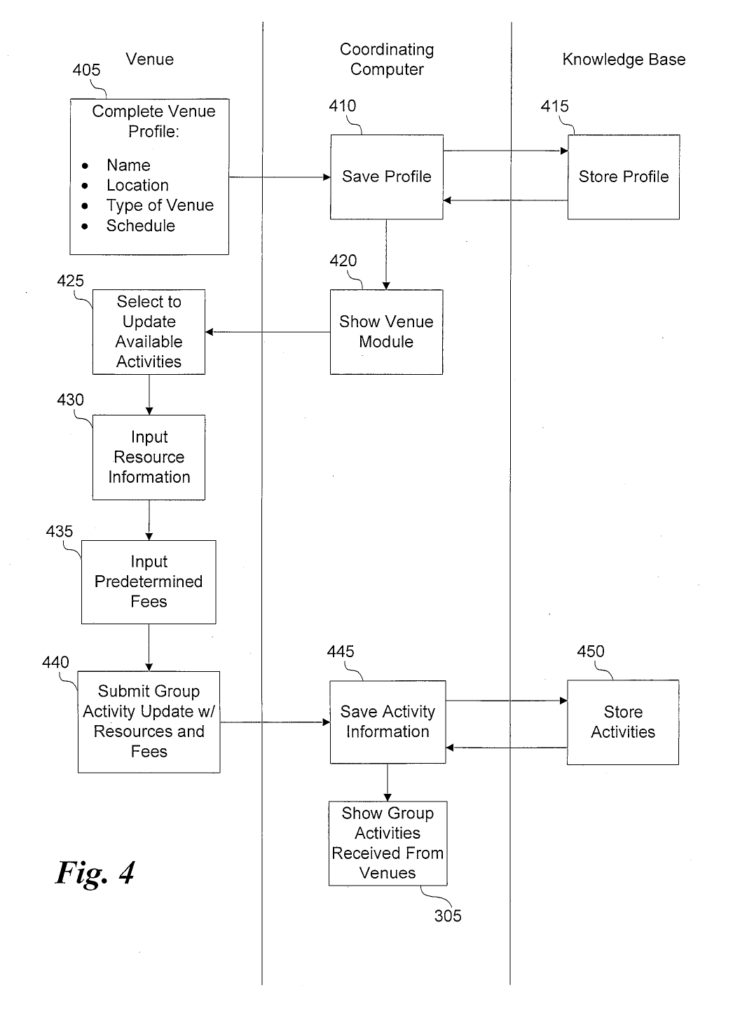

The remaining figures and accompanying description offer additional details as to how various aspects of the overall system illustrated at a high level in FIGS. 1-3 can be implemented. In order for system 100 to provide opportunities for users to arrange participation in a group activity, the group activities are loaded into the system by venues 105 as mentioned above. Illustrated in FIG. 4 is one example of the actions a venue 105 can take to make group activities available to system 100. At 405, a venue profile 140 can be created and populated with information about the venue such as the name, location, type of venue, schedule, map, floor plan, and the like. A venue profile 140 may include any information related to a venue 105, including information useful for choosing the venue and/or activities provided by the venue.

The venue profile 140 may be saved to knowledge base 110 at 410 and 415 using the coordinating computer 115. The coordinating computer may later retrieve the venue profile 140 and make the venue profile 140 available using a venue module (420). The venue module can provide venue users with the ability to update available activities (425). This may include, for example, adding new activities and removing expired or canceled activities. Any group activity may be included, for example, activities for groups having a predetermined size and available for a limited period of time for a predetermined fee may be entered.

When updating activities, a venue user may enter resources (430) that will be used or otherwise encumbered by participants. Resources include, space in the venue, particular tables, rooms, or other meeting locations where participants may be allowed to congregate or be restricted to during the activity. Other resources that may be included in the group activity information include particular equipment or machinery that will be used such as all-terrain vehicles, motorcycles, watercraft, aircraft, a set of gear such as a for SCUBA diving or rock climbing, or other sports equipment such as tents, racquets, balls, paint ball guns, helmets or other protective gear, or any other equipment that may be involved in participating in the group activity. A venue user may also input dates, times, performers, and any other information relevant to the group activity.

A predetermined fee required in order for a group to use the venue 105 and any related resources may be entered as well (435). The predetermined fee may be a single fee required to participate in the activity. The venue may configure the group activity such that it can only be reserved upon payment of the fee in a lump sum rather than by individual payments from each participant.

The venue may submit the updates to available group activities including the resource and fee requirements (440). The coordinating computer can receive the updated activity information and save the information (445) in the knowledge base (450). In another example, the venue may directly interact with the knowledge base to store the activity information (450) (as illustrated in FIG. 2). When stored in knowledge base 110, the activity information received from the venue may be available to users as illustrated in FIG. 3 at 305.

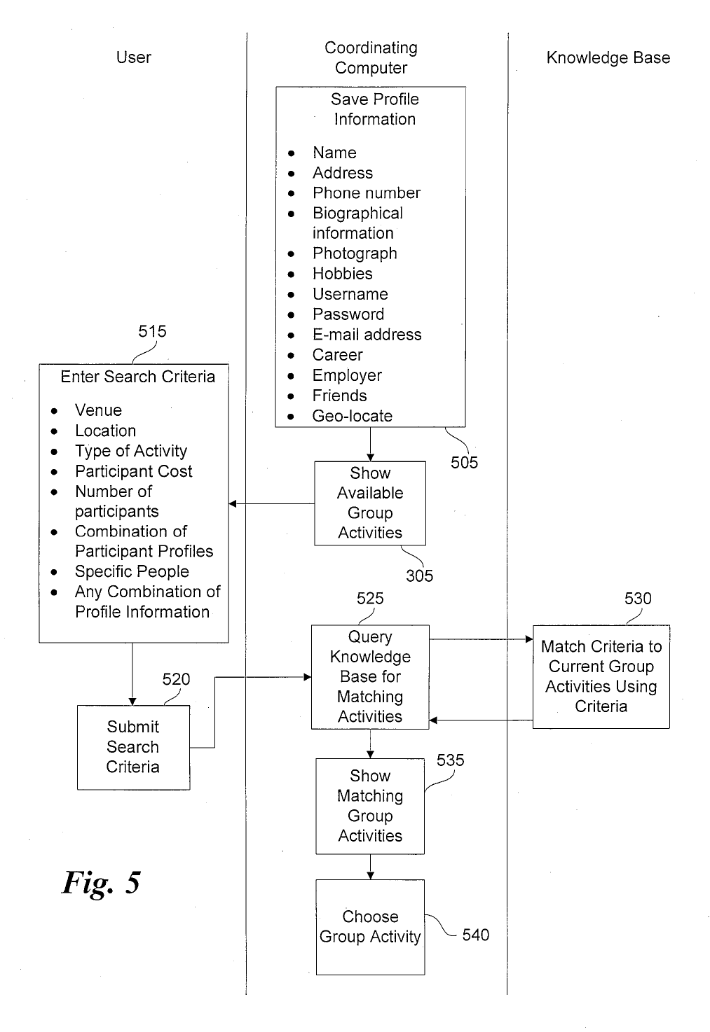

One example of how a user may search for a group activity is illustrated in FIG. 5. A user performing the search may be a potential host user 120 seeking activities to organize, or a potential invitee 130 interested in participating in an activity with others. Alternatively, system 100 may allow an anonymous user who has not submitted profile information 150 to search for available activities to participate in. This might happen in the case where a new user accesses system 100 via a website or mobile app for the first time. The system 100 can be configured to allow any type of user to define search criteria specifying characteristics of potential participants or group activities of interest.

System 100 may require host or invitee users to save profile information 150 (505) that may include identifying or authorizing criteria such as a name, address, telephone number, username, password, and e-mail address, or other personal information. Personal information may include biographical information, a photograph, hobbies or other interests, job title, employer, and information about one or more friends which may be other users of system 100 with profile information 150 or third-parties who do not have profile information. Any suitable information about a user may be included. This profile information may be entered by a user using a personal computing device or by any other suitable means. A user may enter search criteria (515) using any sort of computer or computing device in communication with the coordinating computer. The search criteria may include any suitable criteria for discovering venues with certain events, events at any certain venues, or other participants who are available to participate in a group activity. Examples of search criteria include a particular venue, a location (such as the location of the computing device itself in the user's hand), a type of activity, the participant cost, the number of participants, a certain combination of participant profiles or profile information, specific people, a specific combination of multiple pieces of profile information, and the like.

For example, a user may be interested in finding former classmates who are in the area for a class reunion and may use biographical information from the profile data to locate them. In another example, a user may invite a select subset of the user's friends who have profiles in knowledge base 110 and are linked to the user's profile. In another example, a user may be visiting for a career related convention and may therefore seek out other individuals in a similar career with whom they wish to network at a particular event and therefore may wish to invite them based on career affiliation. In yet another example, a particular user may wish to locate any users of system 100 who are physically within a certain distance away from host user 120 to participate in a particular activity. Profile information may thus include a geo-location option which allows users to be located by other users, an option which the system may allow users to disable. In another example the user may search for group activities with a payment commitment that is less than a user specified upper threshold or greater than a user specified lower threshold. In another example, a user may search for a group activity or may host a group activity that includes only a specific combination of participant profiles. For example a user may search for only group activities that include other couples, other men, or other women. In another example, a user may only seek out other users who have posted a photograph of themselves and may evaluate whether to accept or deny a participant based on their appearance in the profile photograph. These are but a few examples of how the search tool might be configured to operate.

A user can submit search criteria (520), and coordinating computer 115 may query knowledge base 110 for matching activities (525). The knowledge base may match the criteria to current group activities (530) using any sequence of queries or other suitable means. If matching group activities are found, the matching group activities may be presented to the user by the coordinating computer (535) allowing the user to choose a group activity (540) (for example as a host user at 310 in FIG. 3).

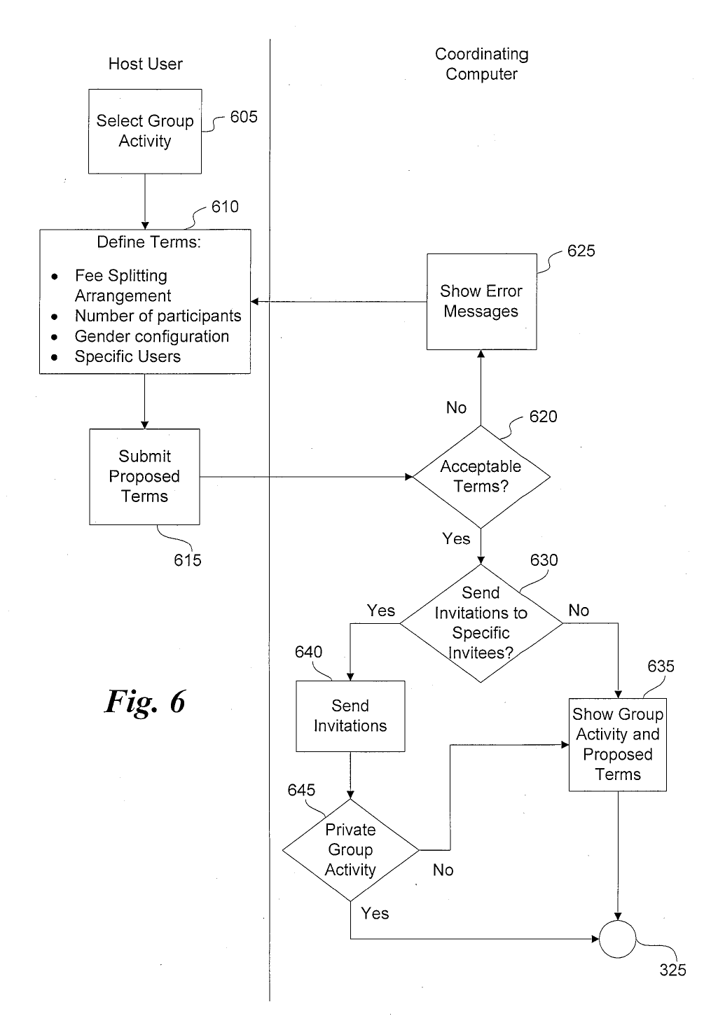

When a user has found a group activity they are interested in organizing, the user may proceed with defining terms for the remaining participants, an example of which is illustrated in FIG. 6. Host user 120 may select a group activity at 605, for example, by selecting from a list provided by the coordinating computer 115. Hosting user 120 may define terms for participation in the group activity (610) such as a fee splitting arrangement, a number of participants, a gender composition for the group defining which genders will be accepted and the numbers for each gender, numbers of specific users or types of users, or any other suitable terms.

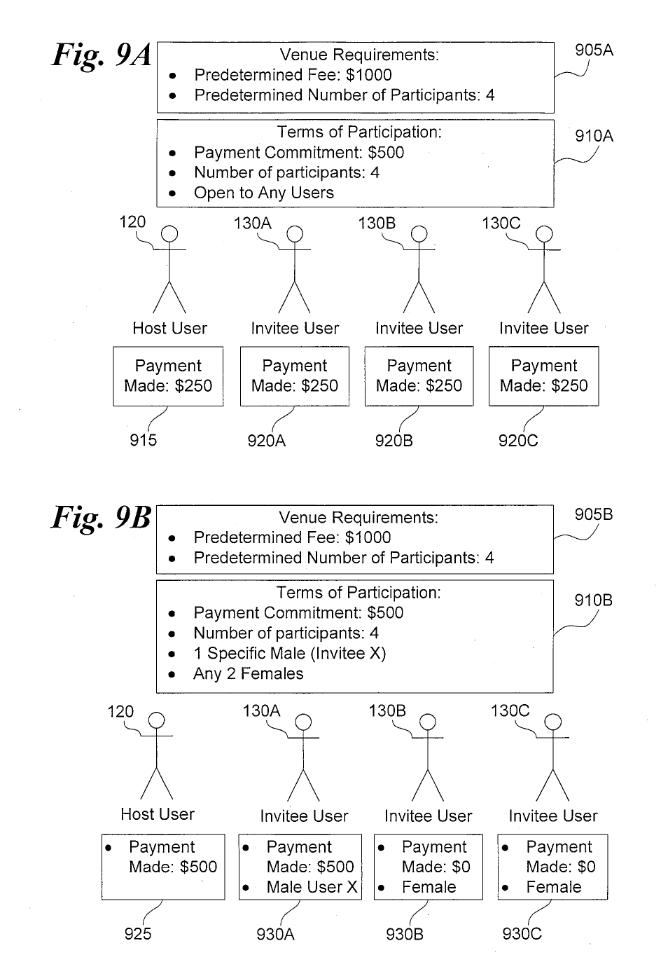

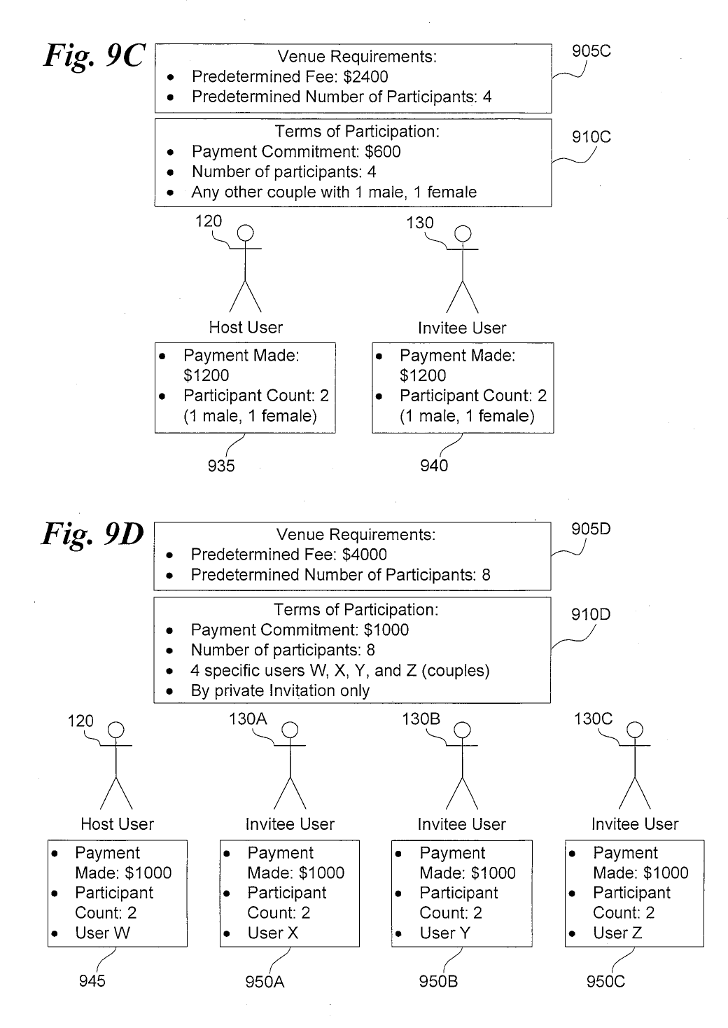

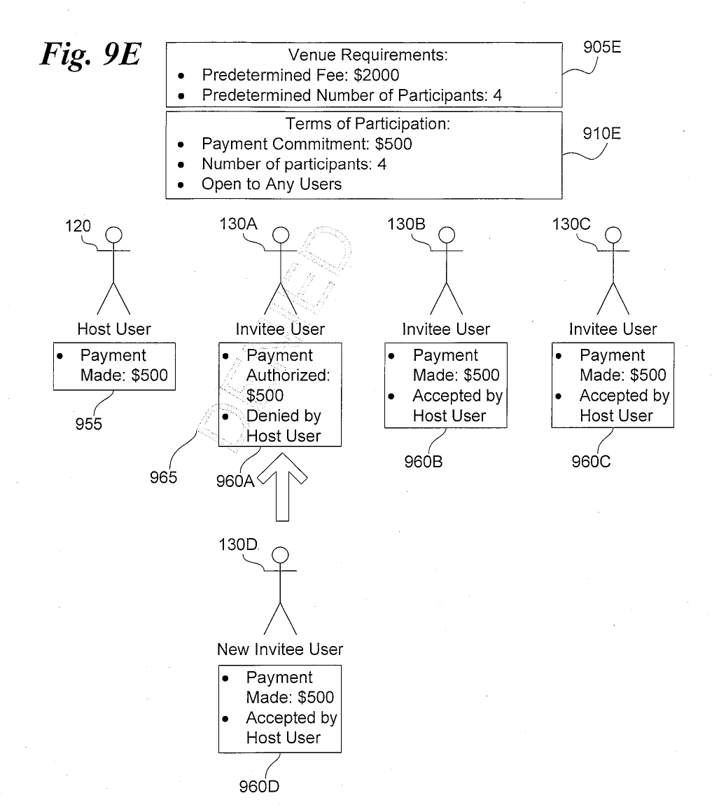

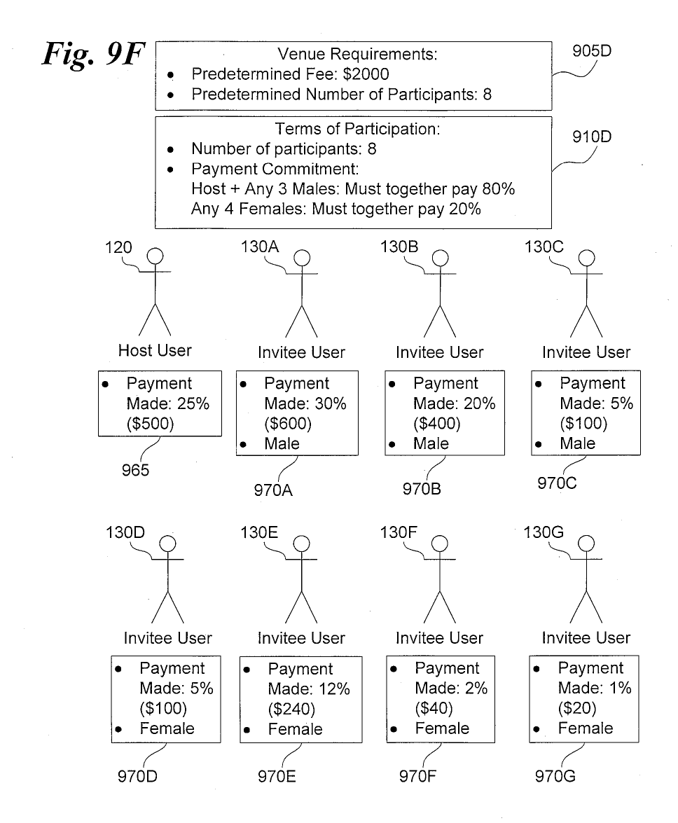

Any suitable arrangement for splitting fees is envisioned and may be provided by system 100. The system may present options to the host 120 allowing the host to define the fee splitting arrangement in terms of a dollar amount per participant or per user, a percentage of the fee per participant or per user, or options allowing participants to agree to pay any amount or percentage of the total they wish to pay. For example, the host may agree to pay a certain dollar amount, and require the remaining invitees to split the remaining cost evenly. In another example, the host may require all male participants to pay all of the fee by splitting the fee payment evenly between them leaving no fee requirement for female participants. In another example, the host may allow each participant to agree to pay whatever amount or percentage of the fee they wish to pay so long as the full fee is paid (and paid before the timeout is reached and the opportunity to organize the activity expires). Further examples of fee splitting arrangements are illustrated in FIGS. 9A-9G.

The host user may submit the proposed terms (615) to the coordinating computer 115 which may include a validation action (620) to determine whether the terms are acceptable based on validation rules. These rules may include input validation rules defined by system 100, rules specific to the particular venue 105 where the event will take place, or any other rules that may be relevant or required to operate system 100. If the terms are not acceptable at 620, the coordinating computer may show error messages (625) and allow the host user to make changes to the definition of the terms at 610.

If the terms are acceptable (620), coordinating computer 115 may determine whether the invitation is to be sent to specific invitees (630). If not, the invitation may be made available for anyone to respond to (635). If the invitation is for specific invitees (630), coordinating computer 115 can send invitations to the invitees specified by host user 120 at 640. If the host 120 has specified the activity is a private activity (645), the process is completed and the host may await the response of invitees 130 who have been targeted for this group activity at 325 (See FIG. 3). However if the group activity is not a private activity (645), then coordinating computer 115 may show the group activity and the proposed terms to searching users at 635 and the host 120 can wait for the response of invitees 130 (325).

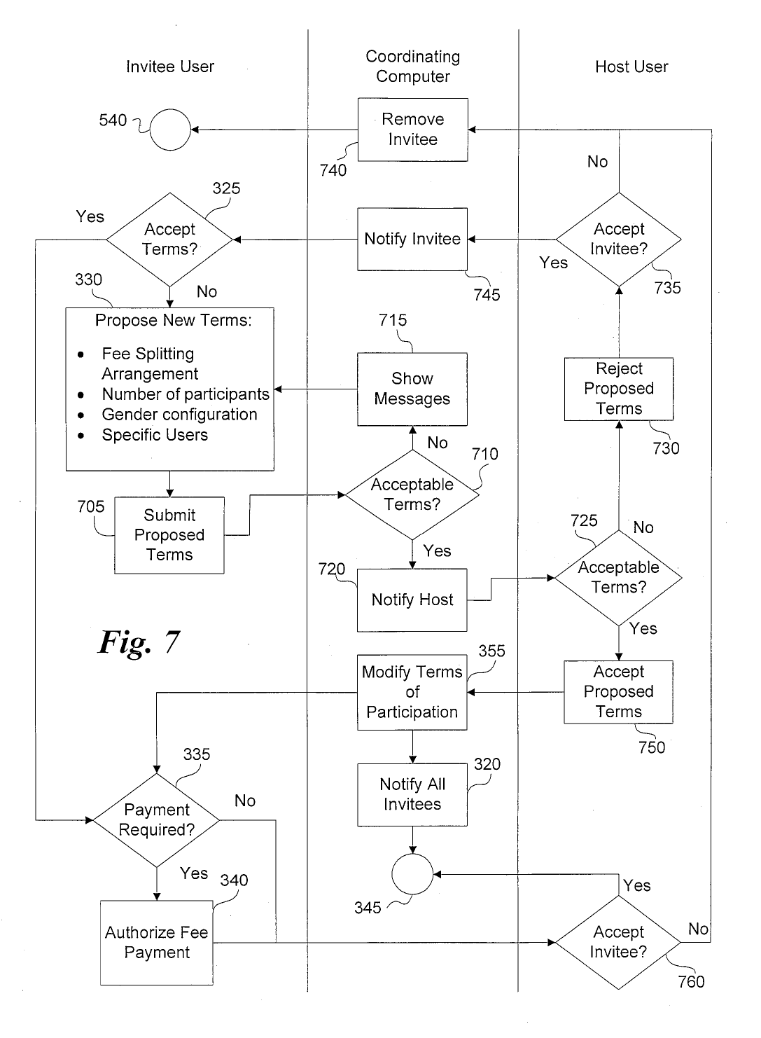

FIG. 3 illustrates as noted above how an invitee may accept terms (325) and authorize a fee and payment (340) under the fee splitting arrangement. However, an invitee may optionally propose new terms of participation and present them for consideration to the host user (330). One example of how this might be accomplished using system 100 is illustrated in FIG. 7 where new terms of participation are proposed at 330. The new terms may include a new fee splitting arrangement, a different number of participants, a different configuration of users, or any other adjustments to the terms.

The proposed terms may be submitted (705) by the invitee for coordinating computer 115 to determine whether or not they are acceptable (710) using the validation rules discussed above. If the terms are not acceptable, coordinating computer 115 may display appropriate messages indicating reasons why the terms are not acceptable at 715 possibly allowing the invitee to modify the new terms (330) and submit them again (705).

If coordinating computer 115 determines that the proposed terms pass the validation rules (710), the coordinating computer may notify the host user at 720 that an invitee wishes to modify the terms of the group activity. If host user 120 does not find the terms proposed by invitee 130 acceptable (725), the host user may select to reject the proposed terms at 730. The host user may also be presented with the option to accept or deny the invitee altogether (735). If the invitee is denied, the coordinating computer 115 may remove the invitee (740) leaving the invitee to choose another group activity, such as from a search result at 540 as illustrated in FIG. 5. If the invitee is accepted at 735, the invitee may be notified at 745 that their proposed terms have been rejected, but allowed to accept the current terms (325) or propose new terms (330).

If the host user finds the proposed terms acceptable at 725, the host user can accept those terms (750) and the coordinating computer may modify terms of participation in the group activity (355). The invitee may make any payments 335, 340, as may be required under the new terms accepted by the host. The new terms may be communicated to all other invitees who have already accepted the previous terms, or may be considering accepting the new terms (320). When invitee 130 has either accepted the original terms (325) or accepted the modified terms (335, 340), host user 120 may determine whether to accept the invitee into the group activity (760). If so, coordinating computer 115 notes the invitee's acceptance and waits for a response from any remaining invitees at 345 as illustrated in FIG. 3. If invitee 130 is rejected by host user 120, coordinating computer 115 can remove the invitee from the group activity (740), and the invitee may choose another group activity such as from a search result (540).

System 100 may also be configured to allow invitees 130 who have already accepted the original terms to remain a part of the group activity under the original terms allowing individuals to maintain the fee splitting arrangement initially agreed to while changing the fee splitting arrangement for any additional invitees. In this configuration, the actions shown in FIG. 7 would be essentially as illustrated except that the notification of invitees at 320 may be limited only to new invitees and may not include invitees who have already accepted the original terms.

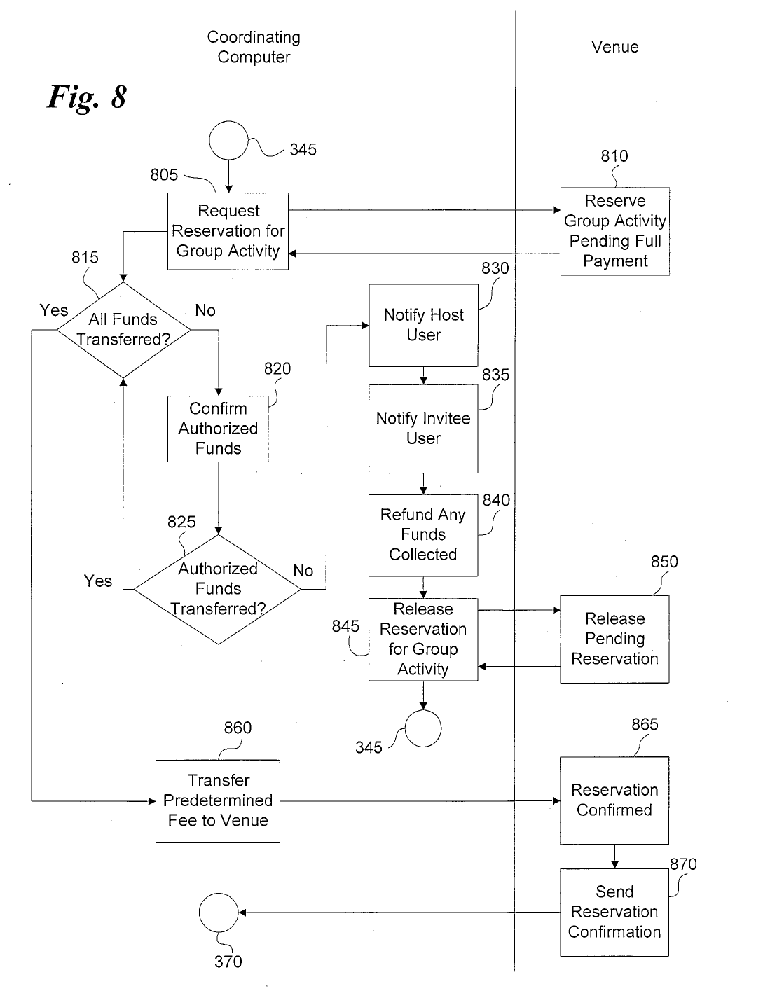

When sufficient invitees 130 have accepted the terms proposed by a host user 120, coordinating computer may reserve the group activity with the venue 105 as illustrated in FIG. 3 at 360. A funds transfer then occurs according to the fee splitting arrangement at 365. An example of how this funds transfer may occur is illustrated in FIG. 8 where system 100 can be configured to confirm whether all paying parties can make payment before transferring any funds or reserving the group activity with venue 105.

Coordinating computer 115 may request a reservation for the group activity at 805 after all invitees 130 have accepted the terms offered by the host 120 at 345. The venue 105 may reserve the group activity in a pending state until full payment is received (810). At this stage of the process, all participants making payments may have both agreed to pay and authorized payments, but no actual payments may have been made.

Authorized funds transfers (340) may be initiated from the participants under the fee splitting arrangement beginning at 815. As noted above, in some cases, the funds transfer may have already taken place at stage 340 for some participants. Remaining participants may be processed at stages 815, 820, and 825 until all funds are transferred from the participants. In some situations, there may be a significant time delay between authorization of funds at stage 340 and transfer of funds beginning at stage 815. The possibility exists that funds authorized in the past may no longer be available when stage 815 begins. System 100 may therefore confirm the presence of sufficient funds (820) for each participant by communicating with the payment provider 160 designated by the participant. If the funds have been authorized for transfer (820), system 100 transfers the funds at 825 and the next participant is considered at 815. If the funds have already been transferred (e.g. at stage 340), payment processing at stages 820 and 825 may not be necessary. This process can continue, for example, sequentially for each participant one after the other until a confirmation of the transfer is obtained by system 100 for all participants. In another configuration, system 100 may process payments in parallel as stages 820 and 825 may be initiated for all participants at about the same time, and the system may then wait at stage 815 for stage 825 to complete for all participants.

If funds authorized by any of the participants cannot be transferred at 825, the host user may be notified (830) and the invitee for whom payment could not be confirmed may be notified (835) as well. The system may offer the participant various options at 835 such as a chance to reconfirm payment using the original payment provider 160, an opportunity to provide authorization information for a different payment provider 160, or the option for the user to decline participation in the group activity. System 100 may be configured to continue with payment processing for other participants or it may be configured to refund any funds received thus far (840). System 100 may also release the reservation at 845 and 850 returning the group activity to a pending state and allowing other groups to obtain the reservation. The group activity may remain in this pending state until another invitee responds to the invitation, or until a time out set by system 100 is reached. System 100 can thus allow multiple host users 120 to attempt to attract multiple groups of invitees for the same group activity for a given venue 105 as discussed above. The first group to confirm payment from all paying participants and provide the required fee to the venue may receive the reservation.

A payment provider may be any organization from which funds may be transferred as authorized by host 120, invitee 130, venue 105, or system 100. Such payment providers include banks such as Citibank providing direct debit, credit, or other Automated Clearing House (ACH) electronic money transfers, wire transfers, transfers directly to and from cash or brokerage accounts, and the like. Payment providers can also include e-commerce providers such as PayPal, financial services companies or credit card providers such as Western Union, Visa, MasterCard, American Express, and Discover, as well as payment transaction processing companies such as VeriFone. These are but an illustrative set that may include any organization capable of assisting in transferring funds electronically through system 100 to venues 105.

When all authorized funds have been successfully transferred (815), the predetermined fee is transferred to the venue (860) to confirm the reservation at 865. The venue 105 may then respond by sending reservation confirmation details at 870 to the host and/or the participants. The reservation confirmation may be delivered and made available to the host and the invitee users (370), for example making it possible for them to present the confirmation at an entrance to the venue 105 to participate in the group activity.

FIGS. 9A-9F illustrate several scenarios of how system 100 can be used as disclosed to arrange the terms of participation for a group activity. FIG. 9A illustrates an example of an open invitation for a group activity organized by a host user 120 splitting the cost of the group activity evenly between all the participants. A venue 105 requires a predetermined fee of $1000 and four participants to reserve the group activity (905A). A host user 120 offers terms of participation 910A including a payment commitment of $250 from each of any four participant invitees 130. Invitee users 130A, 130B, and 130C, respond according to any of the procedures discussed herein using system 100 to accept the terms of participation and make payments 915, 920A, 920B, and 920C of $250 each. These payments together satisfy the predetermined fee of $1000 required by venue 105 making it possible for group consisting of host user 120, and invitees 130 to participate in the group activity together.

In another example illustrated in FIG. 9B, venue 105 has configured the activity to require a predetermined fee of $1000 and four participants. Host user 120 has defined the terms 910B to include a fee-splitting agreement where the host pays $500, and one other specific invitee 130A pays the remaining $500. The terms 910B further require that the remaining two invitees be any two females with no payment commitment. The two female invitees 130B and 130C need only agree to participate. In this example the invitation requires one specific participant, but is not a private invitation because two of the four participants may be any two females. Payments 925 and 930 made by host user 120 and invitee user 130A respectively satisfy the predetermined fee requirement of $1000 set by the venue allowing all four members of the group to participate in the activity together.

System 100 may be configured to allow a user to accept an invitation on behalf of other participants. The concept of a “user” in system 100 can be used to represent a single person, or multiple people. For example, system 100 may be configured to allow a user to provide the number of participants when defining terms for participating in an activity or when accepting an invitation. In this way participants may be involved in group activities who may not be system 100 users themselves and who may not have profile information stored in knowledge base 110.

One example of this scenario is illustrated in FIG. 9C, where venue requirements 905C include a predetermined fee of $2400 and four participants. Host user 120 has organized the activity with terms 910C with four participants and a payment commitment of $600 for each participant. Terms 910C also require that responding invitees be a couple with one male and one female. The couple represented in system 100 as invitee user 130 makes a payment 940 of $1200 that is accepted by host 120 where the participants consist of one male and one female as required by the terms. Host user 120 also makes a payment 935 for $1200 with two participants, one male and one female. In this way the venue requirements 905C of $2400 and four participants are satisfied. In this example, users 120 and 130 represent more than one participant.

Illustrated in FIG. 9D is an example of a private invitation where the predetermined fee requirement from the vendor (905D) of $4000 is required for a group activity with eight participants. Host user 120 (user W) offers terms of participation 910 D which include a payment commitment of $1000, eight participants, and an invitation for specific users W, X, Y, and Z, each having a participant count of 2. The invitation is also sent privately and therefore may only be responded to by the specified users. Payments 945, 950A, 950B and 950C together satisfy the vendor requirement for $4000 and the group activity reservation is confirmed. In this example, four specific users are invited and can “bring a friend.”

As discussed herein, the system may be configured to allow a host user 120 to deny any invitee 130 who has accepted an invitation. This may be helpful or necessary where a host is uncomfortable sharing company with a user who has accepted the invitation. In FIG. 9E, requirements 905E include a predetermined fee of $2000 and four participants. Host user 120 invites any four participants willing to make a payment of $500 each (910E). In this example invitee 130A is denied (965) by host user 120, and new invitee user 130D accepts the now open invitation made available by denied user 130A. Thus payments 955, 960B, 960C, and 960D are sufficient to satisfy the vendor requirement for $2000 and the group activity reservation is confirmed for participants 120, 130B, 130C, and 130D.

Illustrated in FIG. 9F is an example of a host 120 defining terms of participation that include a fee splitting agreement setting broad payment guidelines. In this example, participants can negotiate individually whatever payments they wish to make within the guidelines set by the host user that are also agreeable to other members of the group. In this instance, the host has set terms 910D to require eight participants including the host plus any three males, and any four females. The broader payment commitment requires that the males must agree collectively to pay 80% of the predetermined fee of $2000, and the females must satisfy the remaining 20%. The host initially agrees to a payment 965 of 25% of the fee or ($500). Male invitees 130A-130C negotiate amongst themselves using system 100 finally committing to payments 970A-970C of 30% ($600), 20%(400), and 5%(100) respectively. Female participants 130D-130G similarly negotiate amongst themselves agreeing finally to pay the remaining 20% by splitting the fee into payments 970D-970G of 5% ($100), 12% ($240), 2% ($40), and 1% ($20) respectively. In this example, the participants use the interfaces and communication features of system 100 to negotiate amongst themselves to define and finally accept a payment commitment each participant finds agreeable.

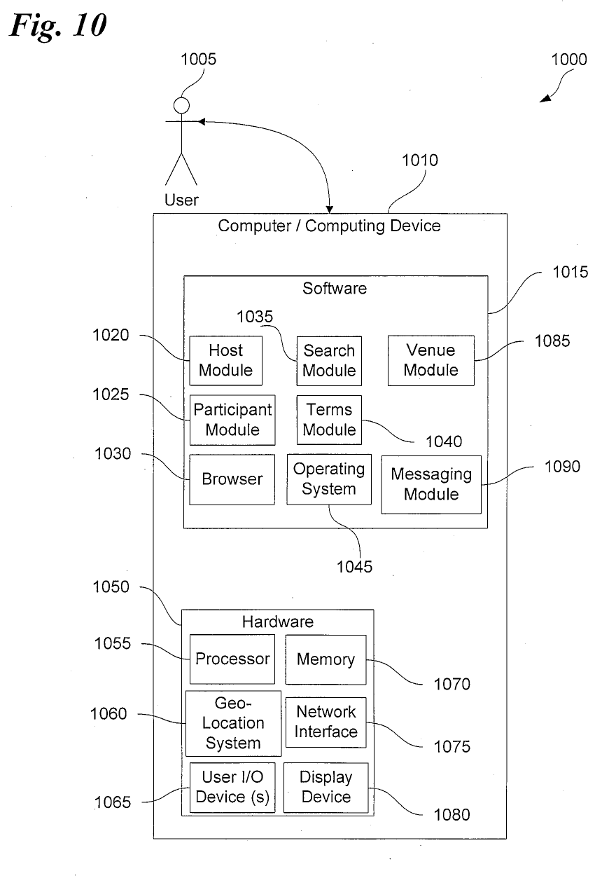

Turning now to software and hardware implementation details, system 100 is a computer implemented system for organizing a group activity for multiple paying parties. Thus the functionality described herein may be implemented in software and executed on any suitable computer hardware. FIG. 10 illustrates at 1000 a computer or computing device 1010 with software 1015 and hardware 1050 configured with capabilities suitable to perform according to the needs of the disclosed system. The software and hardware components illustrated at 1000 are illustrative of aspects that may be found in any suitable combination in any computer or computing device discussed herein. Computing device 1010 thus illustrates software and hardware components that may be found in coordinating computer 115, personal computing devices 125 and 135, knowledge base 110, or available in venues 105. Other software and hardware components may be included as well.

Similarly, user 1005 in FIG. 10 is representative of any user illustrated or discussed herein whether the user is operating in the role of a host user 120, an invitee user 130, a third party user who does not have profile information saved in knowledge base 110, or any other type of user. An example of a third party user is a person or group of people invited by a host user 120 to participate in a group activity 145 who have not previously used system 100. These “third-party” or “anonymous” users may have access to some functionality in the system such as searching for group activities, communicating with a host or other invitees using system 100, and tentatively responding to available invitations. The system may require the establishment of profile information such as the profile information 150 discussed above with respect to step 505 in FIG. 5A before allowing a user to participate in a group activity. Establishing profile information can then transform a third-party or anonymous user into a registered user able to, for example, organize group activities as a host user 120.

For example in the case of a user 1005 using system 100 as a host (host user 120), personal computing device 125 may include some or all of the software components illustrated in computing device 1010. These components may be configured to display input options and generate output using a Graphical User Interface (GUI) allowing the host user to perform the host functions disclosed herein.

Input accepted by host module 1020 can include values defining the terms of participation for the group activity. The terms may include a fee splitting arrangement for dividing the predetermined group activity fee as discussed above. Host module 1020 may also be configured to communicate an invitation that includes the terms from a personal computing device 125 that is like computing device 1010 to a personal computing device 135 that is also like computing device 1010 operated by invitees 130 such as personal computing device 135. The invitation invites other users 1005 (i.e. invitees 130) to participate in the group activity with host user 120 under the terms the host user has defined. Examples of how host module 1020 may operate to provide this hosting functionality are illustrated and described above, for example, with respect to FIG. 3, FIG. 6, and FIGS. 9A-9F. These examples are illustrative rather than restrictive. Any suitable method of providing the functionality described is envisioned.

A participant module may also be included in software 1015 that can allow a user 1005 acting as an invitee (i.e. invitee user 130) to view information about how invitee 130 can accept the invitation from host 120 and confirm payment if necessary according to the fee splitting agreement. Input options may be accepted from invitee user 130 and resulting output may be generated, for example, using the same GUI discussed above with respect to the host module 1020, with the same GUI using different GUI software components, or with a separate GUI. Software 1015 may also include a terms module 1040 which an invitee user 130 may use to propose changes to the terms of participation in the group activity initially set by host user 120. As with the host module 1020, and participant module 1025, a GUI may be used to accept input and display output to an invitee 130 allowing the invitee to change the parameters of participation in the group activity. For example, a user may change how the predetermined fee required by the venue 105 is divided between the host 120 and invitees 130. A user may also propose changes to the number of invitees. Terms module 1040 may also allow host user 120 to accept or decline the proposed changes, and may be configured to notify the invitees 130 of changes to the terms. Non-limiting examples of how the participant module 1025 and terms module 1040 may proceed appear in FIGS. 3 and 7 and are described above.

A search module 1035 may also be included with software 1015 of system 100. Search module 1035 may be configured to except search criteria from a user 1005 who may be a host user 120, invitee 130, a third-party user, or other user. The search criteria may be entered as input by user 1005 using a GUI or other software components and communicated to knowledge base 110. Knowledge base 110 may be configured to search for user and/or group activity information based on the search criteria provided and return the information matching the search criteria to search module 1035 for display to the user. Search module 1035 may accept as input from the user or may automatically provide location information as part of the criteria. The criteria may also include venue, type of activity, number of participants, time and date for the group activity, a payment commitment amount required to satisfy the predetermined fee (i.e. participant cost), the gender composition of the invitees who have already accepted or are required by the terms, specific people, or any other suitable search criteria alone or in combination. Suitable search criteria may include any information, or data fields related to profile infoimation for a user, venue, or information about a group activity.

Computer 1010 may include a venue module 1085 configured to accept input from a user 1005 for completing a venue profile 140 that can include any information about the venue that may be important to system 100 such as the venue name, location, type of venue, and a schedule of activities. Venue module 1085 may be configured to accept input from a user 1005 updating details about available group activities 145 or providing updates to available resource information for venue 105 that may be reserved by a group for a group activity. Venue module 1085 may also be configured to accept input setting the predetermined fees for the available resources, spaces, areas, or meeting locations that will be used for the group activities and optionally allowing the user to post this information to system 100. In one example, venue module 1085 may pass the information to coordinating computer 115 whereas in another example, venue module 1085 may be configured to store the activity information directly in knowledge base 110. Examples of these types of actions are illustrated in greater detail in FIG. 4 and described herein.

A messaging module 1090 may also be included as well in software 1015 that users 1005 may use to communicate while using system 100. Such communications may include communicating invitations, sending information where invitations may be viewed, scheduling where to meet to participate in the group activities, and the like. Messaging module 1090 may be provided as a proprietary communications or messaging component of system 100, or system 100 may engage messaging module 1090 as a separate software tool already installed on or provided by computing device 1010. Messaging module 1090 may provide status update messages, warning messages, informational or marketing messages, and others as discussed elsewhere. These messages may be configured by venues 105 using venue module 1085 which may be configured to control the content of the messages, when they appear and for how long, and to whom to interact with aspects of messaging module 1090

Any suitable messaging technology may be used in facilitating the communications and any suitable communication subsystem may be engaged by messaging module 1090 to orchestrate the information exchange between users 1005. Messaging technologies include various e-mail clients, chat clients such as Pidgin, AOL Instant Messenger, Google Talk, MySpaceIM, ICQ, and the like, as well as text messaging software such as Short Message Service (SMS) text messaging services which may be included with the specific computing device such as part of operating system 1045. In this way, system 100 allows users 1005 to communicate with one another using proprietary messaging software in messaging module 1090, existing messaging software engaged by messaging module 1090, or any combination thereof.

A computer 1010 may also include various other supporting software packages or frameworks such as a browser 1030 usable in connecting over a computer network such as the internet. Examples of commercially available browsers include Google Chrome, Apple Safari, Mozilla Firefox, and Windows Internet Explorer to name a few. In one example of system 100, host module 1020, participant module 1025, search module 1035, terms module 1040, venue module 1085 and any other system software may be hosted on a remote computer 1010 such as coordinating computer 115. In this configuration, user 1005 may interact with these modules of software 1015 through browser 1030 as an internet or Web application operating in a remote environment as a web-based application using a Software-as-a-Service (SaaS) architecture. In this configuration, modules 1020, 1025, 1035, 1040, and 1080 run on one computing device 1010 such as coordinating computer 115 and provide access to HyperText Markup Language (HTML) pages (or dynamically generate the pages) to provide a GUI on another computing device 1010 such as personal computing devices 125 or 135 and the like. In this way a user 1005 such as an invitee, host, or any other kind of user may need nothing other than a web browser 1030 as the HTML pages provided by the SaaS environment can accept input and display output accordingly to implement system 100 as disclosed herein.

In another example, modules 1020, 1025, 1035, 1040, and 1085 (and any others) may be included in a software application such as in an “app” downloaded from an app provider. Such providers include the Apple App Store for iOS based mobile devices, Google Play or Amazon Appstore for Android based mobile devices, or any website from which the app may be downloaded. These apps may be configured to operate on a computing device 1010 such as a personal computing device 125 and 135. In this example, personal computing devices 125 and 135 may be any kind of portable computing device capable of supporting and installing a downloadable app including PDAs, Blackberries, iPhones, iPads, and any kind of smart phone or tablet computer. The software 1015 on personal computing devices 125 and 135 may provide a GUI accepting input and displaying output to host user 120 or invitee 130 (or any other user) using the device and may include some or all of the functionality discussed herein. Personal computing devices 125 and 135 may coordinate the interactions between invitees 130 and hosts 120 disclosed herein by directly communicating between each other and knowledge base 110 (see FIG. 2) operating in a “peer-to-peer” configuration with respect to users 1005 in various roles. This peer to peer configuration operates within the context of communicating with knowledge base 110 venues 105 as well to coordinate the payments and reservations.

The software components and modules discussed herein may be implemented in any suitable programming language or programming architecture. Examples include Java, C++, C#, Javascript, Python, Scala, Perl, Ruby, or any combination thereof. Naming conventions for various languages can vary widely, as well as naming preferences of individual software developers. Therefore the resulting software structures, components, objects, variable names, references, and the like may not carry the precise names used herein but may be structurally and functionally equivalent.

Personal computing devices 125 and 135 may include software 1015 which may be configured to communicate with another computing device 1010. For example, one example of a computing device 1010 configured this way may be a coordinating computer 115 including different implementations of modules 1020, 1025, 1035, 1040, and 1085 configured to operate “server-side” accepting input from personal computing devices 125 and 135, processing as disclosed herein, and exchanging information. Coordinating computer 115 may coordinate communications between apps installed on personal computing devices 125 of host users, personal computing devices 135 of invitees, and knowledge base 110.

It should be understood that any combination of the functionality disclosed herein with respect to system 100 may be implemented in various computing devices 1010 which may be configured to operate as coordinating computer 115, personal computing device 125, personal computing device 135 and the like. The functionality may be delegated to particular devices, duplicated in each device, or any combination of thereof Likewise, knowledge base 110 may be implemented in a computing device 1010 which may include some or all of software 1015.

From a hardware perspective, computing device 1010 may include hardware 1050 with any suitable arrangement of hardware components, some examples of which are illustrated in FIG. 10. Hardware 1050 may include a processor 1055 which may comprise one or more processing components configured as a single unit. When in a single-component form, one or more processing “cores” may be configured in a single package. One or more components of the processor may be of the electronic variety defining digital circuitry, analog circuitry, or both. In one embodiment, a processor is of a conventional, integrated circuit microprocessor arrangement, such as one or more PENTIUM, i3, i5 or i7 processors commercially available from INTEL Corporation of 2200 Mission College Boulevard, Santa Clara, Calif. 95052, USA.

When in a multi-component form, processor 1055 may have one or more components located remotely relative to the others. A computing device 1010 may be located in one geographical location or spread across several widely scattered locations with multiple processors linked together to operate as a single computer connected by a network. Just as the concept of a computer is not limited to a single physical device, so also the concept of a “processor” is not limited to a single physical logic circuit or package of circuits but includes one or more such circuits or circuit packages possibly contained within or across multiple computing machines in various physical locations.

Computing device 1010 may include a virtual computing platform with a virtual processor 1055 having an unknown or fluctuating number of physical processors supporting the operation of the systems described herein. The concept of “computer” and “processor” within a computer or computing device encompasses any such processor or computing device serving to make calculations or comparisons as part of disclosed system. Processing operations related to threshold comparisons, rules comparisons, calculations, generating and displaying GUIs, and the like occurring in coordinating computer 115 and personal computing device 125 and 135 may occur, for example, on separate devices, the same device with separate processors 1055, on a virtual computing environment having an unknown number of physical processors 1055 as described above, or on a handheld computer 1010 such as a tablet, smart phone, or laptop.

Computing device 1010 also has a memory 1070. Each memory may include removable media and is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties. Memory 1070 may be packaged within a single physical package within computing device 1010, in a separate physically remote package outside computing device 1010, or coupled to computing device 1010 using a suitable computer network and located remotely from computing device 1010.

Computing device 1010 may include a network interface 1075 for connecting to a computer network. The data and operating logic of system 100 described herein can be embodied in signals transmitted over a network, in programming instructions, dedicated hardware, or a combination of these. Thus communications with the system can be achieved by various wireless or wired computer networks accessed via network interface 1075 such as a Local Area Network (LAN), Municipal Area Network (MAN), Wide Area Network (WAN), such as the Internet, a combination of these, or any other suitable computer network arrangements. These networks may be accessed as a wired connection or wirelessly through a Wi-Fi transceiver in network interface 1075 or via communication with a mobile telecommunications network implementing technology standards such as 3G, 4G, and the like.

Computing device 1010 may also include a geo-location system 1060 capable of determining the geographical location of computing device 1010. One example of such a system is the Global Positioning System (GPS) employing signals 1125 received from one or more GPS satellites 1140. Geo-location system 1060 may also use Internet Protocol (IP) addressing in place of, or in addition to, GPS system to geo-locate computing device 1010. In yet another example, geo-location system 1060 may triangulate signals from multiple radio communication towers such as cellular transmission towers to geo-locate computing device 1010. Any suitable system for geo-location may be used by geo-location system 1060.

Computing device 1010 may be coupled to, or be integrated with, a display device 1080. Likewise, display device 1080 may be of the same type, or a heterogeneous combination of different visual devices for displaying graphics including a GUI. Any of the servers, computers, or computing devices herein disclosed may also include one or more user input output devices 1065 which may include any combination of a keyboard, mouse, touch screen, laser or infrared pointing device, or gyroscopic pointing device to name just a few representative examples. Also, besides a display, computing device 1010 may include one or more other output devices such as a printer or plotter. Any suitable combination of display, input and output device is possible.

Any of the computing devices 1010 may represent a “server computer” in the generic sense and may be a single, physical, computing device such as a desktop computer, a laptop computer, a rack mounted server, or it may be composed of multiple devices of the same type such as a group of computers operating as one device in a networked cluster, or a heterogeneous combination of different computing devices also linked together by a network and operating as one computer. Thus computer 1010 may be composed of one or more physical computing devices having one or more processors and memory as described herein.

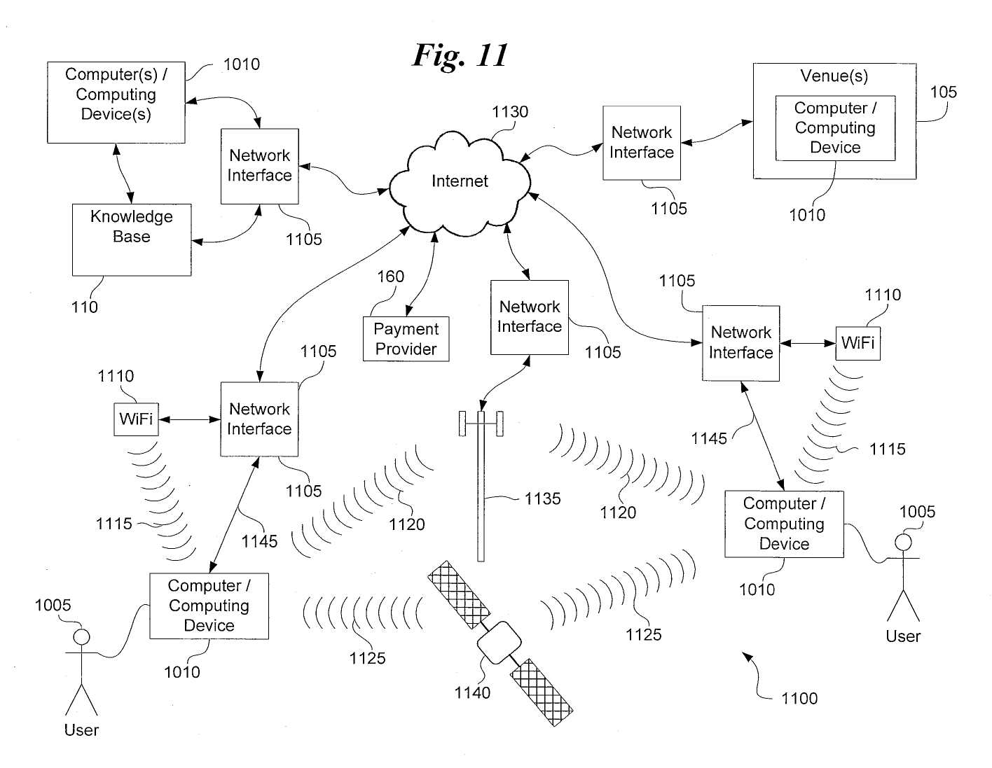

An example of how the various computing devices in system 100 may be configured to communicate appears in FIG. 11 at 1100. Computing devices 1010 may be configured to communicate over wired network connection 1145, or over radio signals 1115 to a WLAN (or WiFi) transceiver 1110. These network communications may pass through a router or firewall or other network interface 1105 before passing over a larger computer network or series of computer networks such as the internet 1130. Communications can also reach the internet 1130 as wireless data transmissions carried over signals 1120 exchanged with a cellular transmitter/receiver 1135 which can be passed through a network interface 1105. Signals 1120 may conform to any of a number of mobile telecommunications technology standards such as 3G, 4G, and the like.

Venues 105 may also be coupled to the internet 1130 through a network interface 1105 interacting with the system 100 as shown at 1100 via a computing device 1010. A venue user may interact with software and hardware modules running on computing device 1010. Venue users can us computing device 1010 to set up venue profiles, update group activity information, and otherwise interact with system 100.

Payment providers 160 may also be accessed via Internet 1130 by any of computing devices 1010 including devices 1010 operated by users 1005 and venue 105. A payment provider may be any organization from which funds may be transferred as authorized by user 1005, venue 105, or system 100. Examples are discussed above and include, Citibank, PayPal, Western Union, Visa, MasterCard, American Express, Discover, and VeriFone to name a few.

As illustrated in FIG. 11, computing device 1010 may be used by a user 1005 as disclosed herein. No limitation with respect to size, capability, specifications, intended purpose, mobility, or any other features or aspects of computing device 1010 is intended in the use of the term “computer” or “computing device”. Any computer or computing device disclosed herein may be suitable as a computing device 1010 and any representations provided with respect to computing devices are illustrative and not restrictive in nature.

External data sources may also be connected to the system via data access devices connected to these communications links, or these data access devices may provide data by other means such as via nonvolatile storage devices such as DVD or CD-ROM, flash memory devices, and the like. Users may also interact with the system by submitting or receive data over the same networks. It shall be appreciated that in alternate forms a user may submit data in an HTML form submission, submit orders, exchange text messages, e-mails, view reports generated by the system as well as other relevant information on computing devices 1010 such as a PDAs, Blackberries, iPhones, iPads, smart phones or tablet computers, to name just a few illustrative examples.

In one embodiment, users interact with the system and disclosed herein using software and hardware operating on computing devices 1010 which may serve HTML pages, send and receive data via web services, and/or other Internet standard or company proprietary data formats, or maintain dedicated client/server connections in order to facilitate the transfer of information between the users and the system, or between the system and outside data sources. As described above, this interaction can take place over a network such as the internet 1130, a WAN, MAN, LAN, or other suitable electronic communications network. Further, it shall be appreciated that the types of communication methods connected within the above described system need not be of the same type, but that digital, analog, and other technologies may be accommodated simultaneously.

A knowledge base such as knowledge base 110 disclosed herein may include any suitable data storage device or software executing on a computer or other device. Some examples include a Relational Database Management System (RDBMS), an Object Database Management System (ODBMS), a file based database system, a collection of binary or text files, a spreadsheet, or any other suitable mechanism for storing and retrieving data.

While the invention has been illustrated and described in detail in the drawings and foregoing description, the same is to be considered as illustrative and not restrictive in character, it being understood that only some examples have been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A computer implemented system for dividing a fee for a group activity between a group of users, comprising:
a coordinating computer accessing a knowledge base, wherein the knowledge base stores data about one or more existing group tables designated by a venue specifically for multiple parties to reserve for a single predetermined fee, wherein the group table has a predetermined number of seats available for multiple participants engaging in a group activity offered by the venue, wherein the seats are not available to be individually reserved separate from the table, and wherein the venue requires payment of the single predetermined fee in order to reserve the group table for a group activity;
a host module configured for use with a host personal computing device, wherein the host module accepts input from a host user defining terms for participating in the group activity offered by the venue that includes reserving a group table, wherein the input includes terms for invitees to collaborate with the host user to pay the single predetermined fee to reserve the group table and participate in the group activity together, the terms including a fee splitting arrangement dividing the predetermined fee; and
a participant module configured for use with the personal computing devices of invitees, wherein the participant module communicates input from the invitees to the coordinating computer about the invitees acceptance of the terms in the invitations, and information about payment commitments made by invitees agreeing to pay a portion of the predetermined fee;
wherein the host personal computing b the host module to control a network to communicate an invitation including the terms for participating in the group activity, the host module inviting invitees to collaborate to pay the predetermined fee and in order to reserve the reserved table as a group under the terms, the host module controlling the participant module via the network, the participant module controlling the personal computing devices of invitees to display the terms;
wherein the personal computing devices of invitees are configured by the participant module to control the network to communicate individual invitee responses to the terms in the invitation the sarticisant module controlling the host module via the network the host module controlling the host personal computing device to display the invitee responses;
wherein the system controls the network to initiate a funds transfer from the invitees who have accepted the invitation to share the reserved table offered by the venue; and
wherein the system controls the network to communicate the reservation for the reserved table to the venue when the predetermined number of participants and the predetermined fee is satisfied and initiates a transfer of the predetermined fee to the venue.

2. The system of claim 1, comprising:
a search module on the personal computing device configured to accept search criteria from a user and control the knowledge base to perform a search based on the search criteria;
wherein the knowledge base is configured to receive the search criteria and to search for user or group activity information matching the search criteria; and
wherein the knowledge base is configured to return to the search module the user or group activity information matching the search criteria.

3. The system of claim 2, wherein the search criteria includes a location automatically provided by the personal computing device.

4. The system of claim 1, wherein the host module is configured to allow the host user to deny participation for an invitee that has accepted an invitation.

5. The system of claim 1, comprising:
a terms module on the personal computing device configured to accept input from a user defining proposed changes to the terms defined by the host user, and wherein the terms module is configured to control the personal computing devices of invitees using the network in order to notify the invitees of the changes to the terms.

6. The system of claim 5, wherein the terms module is configured to allow the user to propose changes to the fee splitting arrangement changing how the predetermined fee is divided between the host and the invitees.

7. The system of claim 1, wherein the coordinating computer is configured to send reservation metadata to the venue when the reservation is sent to the venue.

8. The system of claim 7, wherein the venue analyzes and uses the metadata to define the predetermined fees required to reserve group tables for future group activities.

9. The system of claim 1, wherein the personal computing device with the host module and the coordinating computer are the same computing device.

10. A computer implemented method of dividing a fee for a group activity between a group of users, comprising:
receiving information about one or more existing group tables from a venue and storing the group activity information in a knowledge base using a coordinating computer, wherein the one or more group tables are offered by the venue exclusively for multiple parties to reserve for a single predetermined fee, wherein the one or more group tables include a predetermined number of seats available for a corresponding predetermined number of participants engaging in a group activity offered by the venue, wherein the seats are not available to be individually reserved separate from the corresponding table of the one or more group tables, and wherein the venue requires payment of the single predetermined fee in order to reserve the group table for a group activity;
receiving input from a host personal computing device used by a host user, the host personal computing device coupled to a network in communication with the coordinating computer, the host personal com utin device usin the network to control the coordinating computer to accept the input, wherein the input defines one or more invitees collaborating with the host user to pay the single predetermined fee to reserve the group table and participate in the group activity together with the host user, and wherein the input defines a fee splitting arrangement dividing the predetermined fee;
sending invitations to the invitees requesting the invitees to collectively reserve the group table and participate in the group activity with the host user under the fee splitting arrangement, wherein the invitations are sent to the invitees using the coordinating computer communicating with the personal computing devices of invitees, wherein the coordinating computer controls the personal computing devices of invitees using the network, the personal computing devices of invitees displaying the invitations on corresponding display devices of the individual personal computing devices;
receiving information from the invitees confirming acceptance of the invitation and agreeing to pay part of the predetermined fee, wherein the information is received using the coordinating computer in communication with the personal computing devices of invitees, wherein the personal computing devices of invitees control the coordinating computer using the network to accept the information from the corresponding personal computing devices of invitees;
transferring funds from the invitees using the coordinating computer when a count of confirmed invitees satisfies the predetermined number of participants and the sum of confirmed payments satisfies the single predetermined fee required to reserve the group table; and
reserving the group table for the confirmed invitees using the coordinating computer when the action of transferring the funds is successfully completed.

11. The method of claim 10, comprising:
accepting input modifying the fee splitting agreement after the invitation has been sent, the input received from a user using the personal computing device; and
notifying the invitees of the modified fee splitting agreement using the coordinating computer, wherein the coordinating computer controls the personal computing devices of invitees using the network, the personal computing devices displaying the modified fee splitting agreement on display devices of the corresponding personal computing devices.

12. The method of claim 11, wherein the user modifying the fee splitting agreement is an invitee.

13. The method of claim 10, comprising;
accepting search criteria identifying characteristics of users, group tables, or group activities a searching user is interested in participating in, the search criteria received by the coordinating computer from a personal computing device;
using the coordinating computer to control the knowledge base to execute a search to find information about users, group tables, and group activities matching the search criteria, wherein the coordinating computer controls the knowledge base via the network; and
sending search results with information about matching users, group tables, and group activities to the personal computing device of the searching user.

14. The method of claim 13, wherein the search criteria includes a location automatically provided by the personal computing device.

15. The method of claim 10, wherein the personal computing device of the host and the coordinating computer are the same computing device.

16. A computer implemented method of dividing a fee for a group activity between a group of users, comprising:
using a personal computing device to access information about one or more existing group tables designated by a venue exclusively for multiple parties to reserve for a single predetermined fee the personal computing device controlling a coordinating computer to provide the information about one or more group tables using a network coupled to the personal computing device and the coordinating computer,
wherein the information about the group tables is stored in a knowledge base accessed by the coordinating computer,
wherein the coordinating computer queries the knowledge base to retrieve the information about the one or more group tables accessed by the personal computing device,
wherein the group tables have a predetermined number of seats available for multiple participants engaging in a group activity offered by the venue,
wherein the seats are not available to be individually reserved separate from the corresponding table of the one or more group tables, and
wherein the venue requires payment of the single predetermined fee in order to reserve the group table for a group activity offered by the venue;
using the personal computing device to display a user interface configured to accept input defining terms of participation in a group activity previously offered by the venue that includes reserving a group table, wherein the terms of participation include collaborating with other participants to pay the single predetermined fee to reserve the group table, and wherein the terms of participation include a fee splitting arrangement dividing the predetermined fee;
using the personal computing device to control the respective personal computing devices of one or more invitees, wherein the individual personal computing devices of one or more invitees receives information about the terms of participation from the personal computing device and displays information about the terms on a display device, and wherein the personal computing device uses the network to control the personal computing devices of one or more invitees;
receiving confirmation information from the one or more invitees who have confirmed acceptance of the terms of participation and have agreed to pay part of the predetermined fee, wherein the confirmation information is received using the personal computing device responding to control input received from at least one of the respective personal computing devices of one or more invitees;
transferring funds to the venue according to the terms of the fee splitting agreement using the personal computing device wherein the personal com utin device controls the network to transfer the funds to the venue; and
receiving confirmation from the venue that the group table has been reserved, wherein the confirmation information is received using the personal computing device responding to control input received from the coordinating computer.

17. The method of claim 16, comprising:
using the personal computing device to define search criteria specifying characteristics of potential participants, group tables, or group activities;
controlling the knowledge base to execute a search based on the search criteria using the personal computing device, wherein the personal computing device controls the knowledge base via the network; and
receiving information from the knowledge base about potential participants and group activities via the network using the personal computing device, wherein the information from the knowledge base matches the search criteria.

18. The method of claim 16, wherein sending the terms of participation to one or more invitees includes electronically publishing information about the terms of participation in a public forum.

19. The method of claim 16, comprising:
receiving a message from the venue indicating that the group table has a new predetermined fee that is different from the original predetermined fee, wherein the message is received using the personal computing device responding to control input received from the coordinating computer;
changing the terms of participation to include a new fee splitting arrangement dividing the updated fee using the personal computing device; and
using the personal computing device to control the respective personal computing devices of one or more invitees, wherein the individual personal computing devices of one or more invitees receives the changed terms of participation from the personal computing device and displays information about the changed terms on a display device, and wherein the personal computing device uses the network to control the personal computing devices of one or more invitees.

20. The method of claim 16, comprising:
denying participation for an invitee using the personal computing device, wherein the invitee has previously accepted the terms of participation using that invitee's corresponding personal computing device.
